(19) United States
(12) Patent Application Publication
(10) Pub. No.: US 2025/0252791 A1
(43) Pub. Date: Aug. 7, 2025

(54) DRIVING DATA RECORDER, METHOD, AND COMPUTER PROGRAM FOR RECORDING DRIVING DATA

(71) Applicant: TOYOTA JIDOSHA KABUSHIKI KAISHA, Toyota-shi Aichi-ken (JP)

(72) Inventor: Yuko Izumi, Shibuya-ku Tokyo-to (JP)

(73) Assignee: TOYOTA JIDOSHA KABUSHIKI KAISHA, Toyota-shi Aichi-ken (JP)

(21) Appl. No.: 19/037,356

(22) Filed: Jan. 27, 2025

(30) Foreign Application Priority Data
Feb. 7, 2024 (JP) 2024-017253

(51) Int. Cl. G07C 5/08

(52) U.S. Cl. CPC G07C 5/085

(57) ABSTRACT

A driving data recorder includes a processor configured to store driving data of a vehicle in a volatile memory, copy, every time a first period elapses, the driving data for the first period stored in the volatile memory into one of a first nonvolatile memory and a second nonvolatile memory, and copy driving data for a second period, out of the driving data stored in the one of the nonvolatile memories, from the one of the nonvolatile memories into the other nonvolatile memory at saving timing that is a predetermined time after timing of detection of occurrence of a predetermined event. The second period includes the timing of detection of occurrence of the event and is longer than the first period.

### CROSS-REFERENCE TO RELATED APPLICATIONS

This application claims priority to Japanese Patent Application No. 2024-017253 filed Feb. 7, 2024, the entire contents of which are herein incorporated by reference.

### FIELD

The present disclosure relates to a driving data recorder, a method, and a computer program for recording driving data obtained during travel of a vehicle.

### BACKGROUND

A technique to record data of a traveling vehicle has been proposed (see Japanese Unexamined Patent Publication JP2013-73610A).

In the technique disclosed in JP2013-73610A, an information processor stores first vehicle data for T1 seconds in a volatile memory, while overwriting old data, until a predetermined vehicle state is detected, and stores second vehicle data for T2 seconds in the volatile memory when the vehicle state is detected. The information processor records the first vehicle data from the volatile memory into a nonvolatile memory in response to detection of the vehicle state, and records the second vehicle data from the volatile memory into the nonvolatile memory as necessary before all the second vehicle data for T2 seconds is stored in the volatile memory.

### SUMMARY

In some cases, vehicle data before and after an event that occurs during travel of a vehicle is insufficient to analyze details of the event.

It is an object of the present disclosure to provide a driving data recorder that can record driving data of a vehicle for a relatively long period including timing of occurrence of an event during travel of the vehicle.

According to an embodiment, a driving data recorder is provided. The driving data recorder includes a volatile memory; a first nonvolatile memory; a second nonvolatile memory; and a processor. The processor is configured to: store driving data representing condition of a vehicle or an area around the vehicle during travel of the vehicle in the volatile memory, copy, every time a first period elapses, the driving data for the first period stored in the volatile memory into one of the first nonvolatile memory and the second nonvolatile memory, and copy driving data for a second period, out of the driving data stored in the one of the nonvolatile memories, from the one of the nonvolatile memories into the other of the first nonvolatile memory and the second nonvolatile memory at saving timing that is a predetermined time after timing of detection of occurrence of a predetermined event. The second period includes the timing of detection of occurrence of the event and is longer than the first period.

In an embodiment, the processor is further configured to: determine whether the amount of driving data for the second period is less than or equal to a predetermined transmission upper-limit threshold, transmit driving data for the second period stored in the other nonvolatile memory to another device via a communication terminal mounted on the vehicle at transmission timing after the saving timing, when the amount of driving data is less than or equal to the transmission upper-limit threshold, and transmit a collection request signal to request collection of driving data for the second period to the device via the communication terminal, when the amount of driving data exceeds the transmission upper-limit threshold.

In an embodiment, the processor is further configured to switch between the one of the nonvolatile memories and the other nonvolatile memory, every time a switching period longer than the second period elapses or every time the number of times of copying of driving data for the first period into the one of the nonvolatile memories reaches a predetermined switching number.

In an embodiment, the processor is further configured to detect the occurrence of the predetermined event and that identifies the type of the event that has occurred. The processor determines the length of the second period, depending on the type of the identified event.

In an embodiment, the processor is further configured to detect the occurrence of the predetermined event and that identifies the type of the event that has occurred. The processor determines the type of data item included in the driving data to be copied from the one of the nonvolatile memories into the other nonvolatile memory, depending on the type of the identified event.

According to another embodiment, a method for recording driving data is provided. The method includes storing driving data representing condition of a vehicle or an area around the vehicle during travel of the vehicle in a volatile memory; copying, every time a first period elapses, the driving data for the first period stored in the volatile memory into one of a first nonvolatile memory and a second nonvolatile memory; and copying driving data for a second period, out of the driving data stored in the one of the nonvolatile memories, from the one of the nonvolatile memories into the other of the first nonvolatile memory and the second nonvolatile memory at saving timing that is a predetermined time after timing of detection of occurrence of a predetermined event. The second period includes the timing of detection of occurrence of the event and is longer than the first period.

According to still another embodiment, a non-transitory recording medium that stores a computer program for recording driving data is provided. The computer program includes instructions causing a processor mounted on a vehicle to execute a process including: storing driving data representing condition of the vehicle or an area around the vehicle during travel of the vehicle in a volatile memory; copying, every time a first period elapses, the driving data for the first period stored in the volatile memory into one of a first nonvolatile memory and a second nonvolatile memory; and copying driving data for a second period, out of the driving data stored in the one of the nonvolatile memories, from the one of the nonvolatile memories into the other of the first nonvolatile memory and the second nonvolatile memory at saving timing that is a predetermined time after timing of detection of occurrence of a predetermined event. The second period includes the timing of detection of occurrence of the event and is longer than the first period.

The driving data recorder according to the present disclosure has an advantageous effect of being able to record driving data of a vehicle for a relatively long period including timing of occurrence of an event during travel of the vehicle.

### BRIEF DESCRIPTION OF DRAWINGS

FIG. 1 schematically illustrates the configuration of a vehicle equipped with a driving data recorder.

FIG. 2 illustrates the hardware configuration of the driving data recorder.

FIG. 3 is a functional block diagram of a processor of the driving data recorder.

FIG. 4 is a schematic explanatory diagram of a driving data recording process.

FIG. 5 is an operation flowchart of the driving data recording process.

### DESCRIPTION OF EMBODIMENTS

A driving data recorder, a method for recording driving data executed by the driving data recorder, and a computer program for recording driving data will now be described with reference to the attached drawings. The driving data recorder is mounted on a vehicle, and successively stores driving data representing condition of the vehicle or an area therearound during travel of the vehicle in a volatile memory. Every time a first period elapses, the driving data recorder stores a copy of driving data for the first period stored in the volatile memory into one of two nonvolatile memories (storing a copy of driving data stored in a memory into another memory will be simply referred to as “copying driving data” or “copying and storing driving data,” below). At saving timing that is a predetermined time after timing of detection of occurrence of a predetermined event, the driving data recorder further copies driving data for a second period, which includes the timing of detection of occurrence of the event and which is longer than the first period, from the one of the nonvolatile memories into the other nonvolatile memory. In this way, the driving data recorder records driving data for a relatively long period including timing of occurrence of an event during travel of the vehicle.

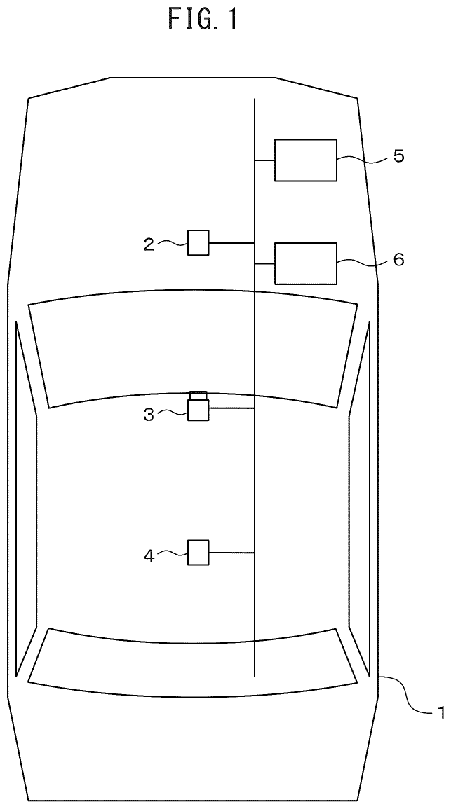

FIG. 1 schematically illustrates the configuration of a vehicle 1 equipped with the driving data recorder. The vehicle 1 includes at least one motion sensor 2, a camera 3, a wireless communication terminal 4, a driving data recorder 5, and an electronic control unit (ECU) 6 that controls components of the vehicle 1. The motion sensor 2, the camera 3, the wireless communication terminal 4, and the ECU 6 are communicably connected to the driving data recorder 5. The vehicle 1 may be provided with a range sensor (not illustrated) that measures the distance to an object in an area around the vehicle 1, such as LiDAR or radar. The vehicle 1 may also be provided with a device (not illustrated) for determining the position of the vehicle 1 by a satellite positioning system, such as a GPS receiver.

The at least one motion sensor 2 measures motion of the vehicle 1. The motion sensor 2 includes, for example, at least one of a speed sensor, an acceleration sensor, or an angular velocity sensor. Each motion sensor 2 generates a sensor signal indicating motion of the vehicle 1, and outputs the sensor signal to the ECU 6. Each motion sensor 2 may also output the generated sensor signal to the driving data recorder 5.

The camera 3 takes pictures of a predetermined region around the vehicle 1 or in the interior of the vehicle 1, generates an image representing the predetermined region every predetermined period, and outputs the generated image to the driving data recorder 5 and the ECU 6. The predetermined region is, for example, a region in front of or behind the vehicle 1, or a region in the interior of the vehicle 1 including the position of the driver of the vehicle 1. The vehicle 1 may be provided with multiple cameras 3 taking pictures in different orientations or having different focal lengths. In the following, an image representing the predetermined region around the vehicle I will be referred to as a “vehicle exterior image.” An image representing the driver will be referred to as a “driver image.”

The wireless communication terminal 4, which is an example of a communication device, is a device to execute a wireless communication process conforming to a predetermined standard of wireless communication, and accesses, for example, a wireless base station (not illustrated) to connect to a server (not illustrated) that collects driving data, via the wireless base station and a communication network. In other words, a communication channel is established between the wireless communication terminal 4 and the server via the wireless base station and the communication network. The wireless communication terminal 4 generates an uplink radio signal including driving data to be collected, which is received from the driving data recorder 5, and transmits the uplink radio signal to the wireless base station, thereby transmitting the driving data to the server.

The ECU 6 controls components of the vehicle 1. More specifically, the ECU 6 assists the driver of the vehicle 1 in driving, using sensor signals from the motion sensor 2. Alternatively, the ECU 6 may execute autonomous driving control of the vehicle 1, using sensor signals from the motion sensor 2. In addition, the ECU 6 outputs a state signal indicating the state of the vehicle 1 to the driving data recorder 5. To this end, when some abnormality is detected in one of the components of the vehicle 1 to be controlled or the ECU 6 itself, the ECU 6 includes information indicating the detected abnormality in the state signal.

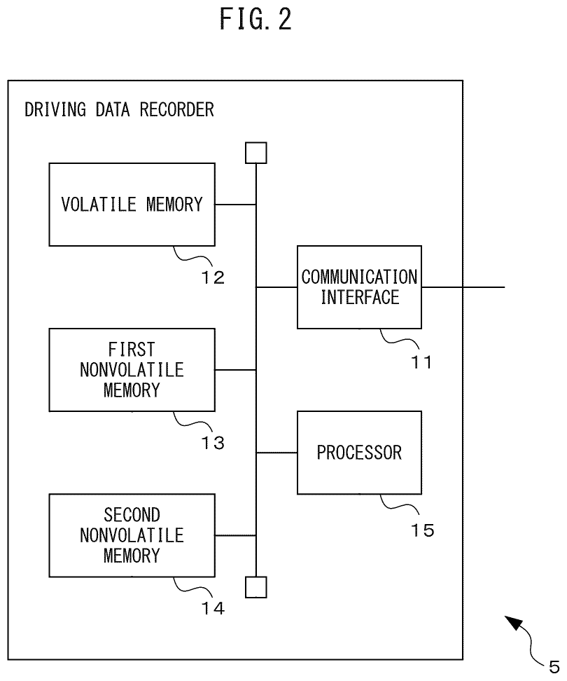

FIG. 2 illustrates the hardware configuration of the driving data recorder 5. The driving data recorder 5 includes a communication interface 11, a volatile memory 12, a first nonvolatile memory 13, a second nonvolatile memory 14, and a processor 15. The driving data recorder 5 may also be provided with an external interface (not illustrated) used for connecting a peripheral and conforming to a predetermined interface standard, such as USB (registered trademark).

The communication interface 11, which is an example of an in-vehicle communication unit, includes an interface circuit for communicably connecting the driving data recorder 5 to each motion sensor 2, the camera 3, the wireless communication terminal 4, and the ECU 6. Every time a sensor signal is received from each motion sensor 2, the communication interface 11 passes the received sensor signal to the processor 15. The communication interface 11 may receive a sensor signal from each motion sensor 2 via the ECU 6. Every time an image is received from the camera 3, the communication interface 11 passes the received image to the processor 15. Every time information from the server is received from the wireless communication terminal 4, the communication interface 11 passes the information to the processor 15. When a state signal indicating the state of the vehicle 1 is received from the ECU 6, the communication interface 11 passes the state signal to the processor 15. Further, the communication interface 11 outputs driving data received from the processor 15 to the wireless communication terminal 4.

The volatile memory 12 is configured as an integrated circuit of volatile semiconductor memory, such as DRAM or SRAM. In the present embodiment, the volatile memory 12 is configured as a ring buffer, into which driving data is successively written by the processor 15. The volatile memory 12 has a storage area large enough to store data the amount of which is the product of the amount corresponding to driving data obtained in a period having a first length (hereafter simply a “first period”) and a predetermined margin factor (1 or greater, e.g., 1.1 to 1.3). The first period is a time period in units of which driving data stored in the volatile memory 12 is copied into the first nonvolatile memory 13 or the second nonvolatile memory 14, and is set, for example, to a length of several minutes to a dozen or so minutes. When the storage area of the volatile memory 12 becomes full, driving data is overwritten in chronological order.

The first nonvolatile memory 13 and the second nonvolatile memory 14 are each configured as an integrated circuit of nonvolatile semiconductor memory. The first nonvolatile memory 13 and the second nonvolatile memory 14 may be configured as separate integrated circuits or different storage areas in a single integrated circuit.

Into one of the first nonvolatile memory 13 and the second nonvolatile memory 14, driving data stored in the volatile memory 12 is copied in units of the first period. Into the other of the first nonvolatile memory 13 and the second nonvolatile memory 14, driving data for a period having a second length (hereafter simply a “second period”) stored in one of the first nonvolatile memory 13 and the second nonvolatile memory 14 is copied after detection of a predetermined event. Thus the first nonvolatile memory 13 and the second nonvolatile memory 14 each have a storage area large enough to store data the amount of which is the product of the amount corresponding to driving data obtained in the second period and a predetermined margin factor (1 or greater, e.g., 1.1 to 1.3).

The processor 15 includes one or more central processing units (CPUs) and a peripheral circuit thereof. The processor 15 may further include another operating circuit, such as a logic-arithmetic unit, an arithmetic unit, or a graphics processing unit. The processor 15 executes a driving data recording process during travel of the vehicle 1.

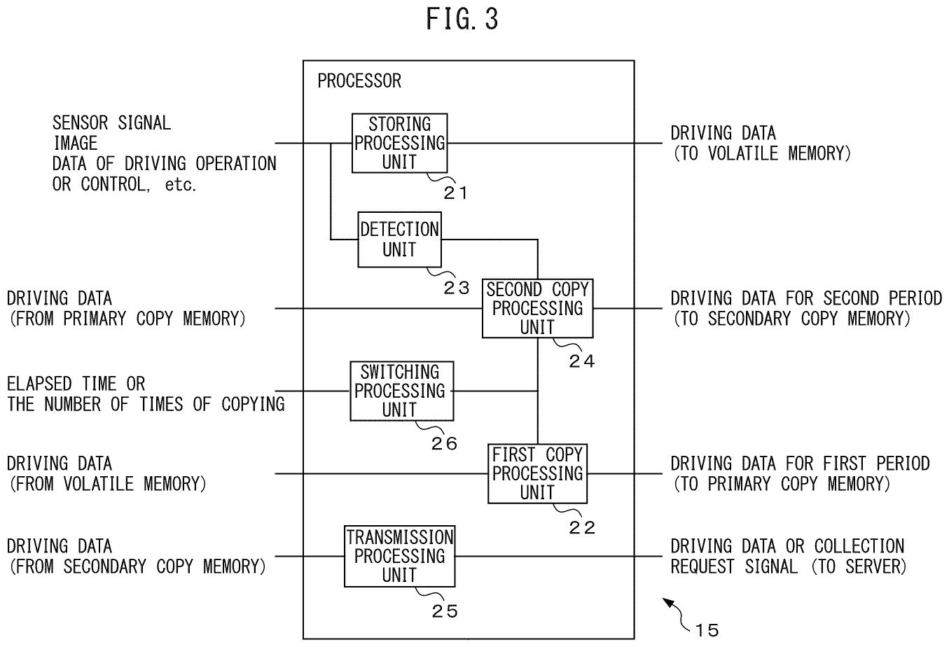

FIG. 3 is a functional block diagram of the processor 15, related to the driving data recording process. The processor 15 includes a storing processing unit 21, a first copy processing unit 22, a detection unit 23, a second copy processing unit 24, a transmission processing unit 25, and a switching processing unit 26. These units included in the processor 15 are, for example, functional modules implemented by a computer program executed by the processor 15, or may be dedicated operating circuits provided in the processor 15.

The storing processing unit 21 successively stores driving data in the volatile memory 12. As described above, driving data represents condition of the vehicle 1 or an area around the vehicle 1 during travel of the vehicle 1. Driving data includes, for example, at least one of a value indicating motion of the vehicle 1 indicated by a sensor signal from the motion sensor 2, a vehicle exterior image or a driver image obtained by the camera 3, a value related to driving operation or control of the vehicle 1 obtained from the ECU 6, or data indicating the operating state of the ECU 6. A value indicating motion of the vehicle 1 includes, for example, at least one of the speed, acceleration, or angular velocity of the vehicle 1. A value related to driving operation or control of the vehicle 1 includes, for example, at least one of the steering angle, the degree of accelerator opening, the amount of depression of the brake pedal, remaining battery power, lighting mode of the headlights, or operating mode of the windshield wiper. When the vehicle 1 is provided with a range sensor, driving data may further include the distance to an object in an area around the vehicle 1 indicated by a ranging signal generated by the range sensor. When the vehicle 1 is provided with a position determining device, such as a GPS receiver, driving data may further include the position of the vehicle 1 determined by the device.

Every time a set of data to be included in driving data is received from the motion sensor 2, the camera 3, and the ECU 6, the storing processing unit 21 includes the set of data in a single piece of driving data to generate driving data. Specifically, the storing processing unit 21 includes the set of data in driving data according to a predetermined format of driving data to generate a single piece of driving data. The storing processing unit 21 may compress the set of data according to a predetermined compression format, and then include the compressed data in driving data. A single piece of driving data includes a set of data whose difference in timing of reception by the driving data recorder 5 is within a predetermined allowable time (e.g., 100 msec to 1 second). In driving data, the storing processing unit 21 may include time information indicating the time of generation of the driving data. Every time driving data is generated, the storing processing unit 21 stores the generated driving data in free space of the volatile memory 12. However, when the volatile memory 12 does not have enough free space to store driving data, the storing processing unit 21 overwrites the oldest driving data, out of the driving data stored in the volatile memory 12, with the latest driving data.

Every time the first period elapses, the first copy processing unit 22 copies the latest driving data for the first period stored in the volatile memory 12 into one of the first nonvolatile memory 13 and the second nonvolatile memory 14. The first copy processing unit 22 may delete the original driving data stored in the volatile memory 12, or leave the data as it is. Out of the first nonvolatile memory 13 or the second nonvolatile memory 14, a nonvolatile memory into which driving data is copied from the volatile memory 12 will be referred to as a “primary copy memory,” below. A flag for identifying the primary copy memory and the other nonvolatile memory is stored in a storage area other than the storage area for driving data in the first nonvolatile memory 13 or the second nonvolatile memory 14. By referring to the flag, the first copy processing unit 22 identifies which of the first nonvolatile memory 13 and the second nonvolatile memory 14 is the primary copy memory.

Into the primary copy memory, driving data is sequentially written in units of the first period after the ignition switch of the vehicle 1 is turned on. Thus, until the storage area of the primary copy memory becomes full, all the driving data after the ignition switch is turned on is stored. When the storage area of the primary copy memory becomes full, the first copy processing unit 22 overwrites the oldest driving data for the first period, out of the driving data stored in the primary copy memory, with the latest driving data for the first period.

Every time copying of driving data for the first period into the primary copy memory is finished, the first copy processing unit 22 notifies this fact to the switching processing unit 26.

The detection unit 23 detects the occurrence of a predetermined event in or around the vehicle 1. A predetermined event is one that requires collection of driving data before and after the timing of occurrence of the event, and may be, for example, an accident, emergency avoidance of some danger by the vehicle 1, or an abnormal occurrence in the driver of the vehicle 1.

Thus the detection unit 23 determines whether a value indicating motion of the vehicle 1 indicated by a sensor signal from the motion sensor 2, a value from the ECU 6 related to driving operation or control of the vehicle 1, or data indicating the operating state of the ECU 6 satisfies a predetermined event detection condition. When the predetermined event detection condition is satisfied, the detection unit 23 determines that a predetermined event has occurred, and detects the occurrence of the event. When the predetermined event detection condition is not satisfied, the detection unit 23 does not detect the occurrence of a predetermined event.

The event detection condition may be, for example, that the absolute value of the acceleration or angular velocity of the vehicle 1 indicated by a sensor signal from the motion sensor 2 exceeds a predetermined threshold. Alternatively, the event detection condition may be that the amount of change in the steering angle received from the ECU 6 in a predetermined sampling interval (e.g., 100 msec to 1 second) exceeds a predetermined threshold. Alternatively, the event detection condition may be that data indicating the operating state of the ECU 6 includes a value indicating some failure.

The detection unit 23 may determine whether the event detection condition is satisfied, based on a vehicle exterior image or a driver image from the camera 3. In this case, the detection unit 23 inputs a vehicle exterior image or a driver image into a classifier that has been trained to determine whether a predetermined event has occurred. When the classifier outputs the result of determination that a predetermined event has occurred, the detection unit 23 determines that the event detection condition is satisfied. The classifier is configured as a deep neural network (DNN) of a convolutional neural network (CNN) type including, in order from the input side, one or more convolution layers and one or more fully-connected layers. Alternatively, the classifier may be configured based on a machine learning technique other than a neural network, such as a support vector machine or AdaBoost. Such a classifier is trained in advance in accordance with a predetermined supervised learning technique, such as backpropagation, with a large number of training images including images each representing a situation corresponding to a predetermined event, e.g., some accident or abnormality.

When the occurrence of a predetermined event is detected, the detection unit 23 notifies this fact to the second copy processing unit 24.

The second copy processing unit 24 copies driving data for the second period, out of the driving data stored in the primary copy memory, from the primary copy memory into the other of the first nonvolatile memory 13 and the second nonvolatile memory 14 at saving timing that is a predetermined time (e.g., several dozen seconds to several minutes) after timing of detection of occurrence of a predetermined event. In the following, the other of the first nonvolatile memory 13 and the second nonvolatile memory 14 will be referred to as the “secondary copy memory.”

The second period includes the timing of detection of occurrence of the event and is longer than the first period, and may be, for example, a period of several dozen minutes to 1 hour or longer. Thus, when the timing at which the ignition switch is turned on precedes the timing that is the upper-limit length of the second period earlier than the saving timing (hereafter the “upper-limit-length start timing”), the second copy processing unit 24 sets the upper-limit-length start timing as the start timing of the second period. When the upper-limit-length start timing precedes the timing at which the ignition switch is turned on, the second copy processing unit 24 sets the timing at which the ignition switch is turned on as the start timing of the second period. In the above-described example, the saving timing is set as the end of the second period, but the end of the second period, which follows the timing of detection of occurrence of the event, may precede the saving timing.

When copying of driving data for the second period into the secondary copy memory is finished, the second copy processing unit 24 notifies this fact to the transmission processing unit 25. When coping into the secondary copy memory is finished, the second copy processing unit 24 may delete the original driving data stored in the primary copy memory, or leave the data as it is. When the ignition switch of the vehicle 1 is turned off without a predetermined event being detected, the second copy processing unit 24 may delete driving data stored in the primary copy memory.

When notified that coping of driving data for the second period into the secondary copy memory is finished, the transmission processing unit 25 thereafter transmits driving data for the second period stored in the secondary copy memory to the server via the communication interface 11 and the wireless communication terminal 4 at predetermined transmission timing. The server is an example of another device.

The predetermined transmission timing may be, for example, timing immediately after the notification that coping of driving data for the second period into the secondary copy memory is finished, or any timing between the timing immediately after the notification and the turn-off of the ignition switch of the vehicle 1. Alternatively, the predetermined transmission timing may be the timing of the next turn-on of the ignition switch after the ignition switch is once turned off.

According to a modified example, the transmission processing unit 25 may determine whether the amount of driving data for the second period stored in the secondary copy memory is less than or equal to a predetermined transmission upper-limit threshold. The transmission upper-limit threshold is set as a value corresponding to the amount of data that can be communicated in a predetermined time (e.g., several minutes) by the wireless communication terminal 4. When the amount of data is less than or equal to the transmission upper-limit threshold, the transmission processing unit 25 transmits driving data for the second period stored in the secondary copy memory to the server via the communication interface 11 and the wireless communication terminal 4 at the transmission timing. When the amount of driving data for the second period exceeds the transmission upper-limit threshold, the transmission processing unit 25 transmits a collection request signal to request collection of driving data for the second period via the communication interface 11 and the wireless communication terminal 4 to the server at the transmission timing. In the collection request signal, the transmission processing unit 25 includes identifying information of the vehicle 1 and information indicating the amount of driving data for the second period. In this case, driving data stored in the secondary copy memory is outputted to a peripheral (not illustrated) connected via the external interface. The transmission processing unit 25 may cause a message to appear on a display (not illustrated) included in the driving data recorder 5 or provided in the interior of the vehicle 1 to instruct the driver to go to a facility that can collect data.

According to this modified example, the transmission processing unit 25 can appropriately determine whether to transmit driving data by wireless communication or to have driving data collected separately, depending on the amount of driving data stored in the secondary copy memory.

After transmission of driving data via the wireless communication terminal 4 or output of driving data to a peripheral, the transmission processing unit 25 deletes the driving data from the secondary copy memory. When driving data stored in the secondary copy memory is not collected even after a certain period (e.g., several days to several weeks) from transmission of a collection request signal to the server, the transmission processing unit 25 may delete the driving data from the secondary copy memory.

When the amount of driving data for the second period exceeds the transmission upper-limit threshold, the transmission processing unit 25 may transmit driving data for a third period shorter than the second period, together with a collection request signal, to the server via the communication interface 11 and the wireless communication terminal 4. In this case, the third period includes the timing of occurrence of an event and may be a period of several dozen seconds to several minutes. When it is determined on the server side that the whole driving data for the second period is necessary, driving data for the second period may be collected via the external interface. When it is determined on the server side that the whole driving data for the second period is unnecessary, the server may transmit a discard instruction to the vehicle 1. When a discard instruction is received via the wireless communication terminal 4 and the communication interface 11, the transmission processing unit 25 may delete all the driving data stored in the secondary copy memory.

The switching processing unit 26 switches between the primary copy memory and the secondary copy memory, every time a predetermined switching period elapses or every time the number of times of copying of driving data for the first period into the primary copy memory reaches a predetermined switching number. The predetermined switching period may be a period longer than the second period, e.g., several to several dozen times longer than the second period. At each switching between the primary copy memory and the secondary copy memory, the switching processing unit 26 stores the date and time of the switching in a storage area other than the storage area for driving data in the first nonvolatile memory 13 or the second nonvolatile memory 14. The switching processing unit 26 then compares the time elapsed since the date and time of the last switching with the switching period, and switches between the primary copy memory and the secondary copy memory when the elapsed time reaches the switching period. Alternatively, every time notification that driving data for the first period is copied and stored is received from the first copy processing unit 22, the switching processing unit 26 increments the number of times of coping by one, and compares the number of times of copying with a predetermined switching number. When the number of times of copying reaches the predetermined switching number, the switching processing unit 26 switches between the primary copy memory and the secondary copy memory. The predetermined switching number may be several to several dozen times the number of first periods included in the second period. When determining to switch between the primary copy memory and the secondary copy memory, the switching processing unit 26 thereafter executes the switching at the timing when the ignition switch of the vehicle 1 is turned off. However, when driving data is stored in the secondary copy memory, the switching processing unit 26 deletes the driving data from the secondary copy memory and then switches between the primary copy memory and the secondary copy memory. After switching between the primary copy memory and the secondary copy memory, the switching processing unit 26 rewrites the value of the flag for identifying the primary copy memory and the secondary copy memory stored in a storage area other than the storage area for driving data in the first nonvolatile memory 13 or the second nonvolatile memory 14 to the value after switching.

Switching between the primary copy memory and the secondary copy memory at certain intervals in this way results in the two nonvolatile memories being used equally. The driving data recorder 5 can therefore reduce the occurrence of failures of the two nonvolatile memories.

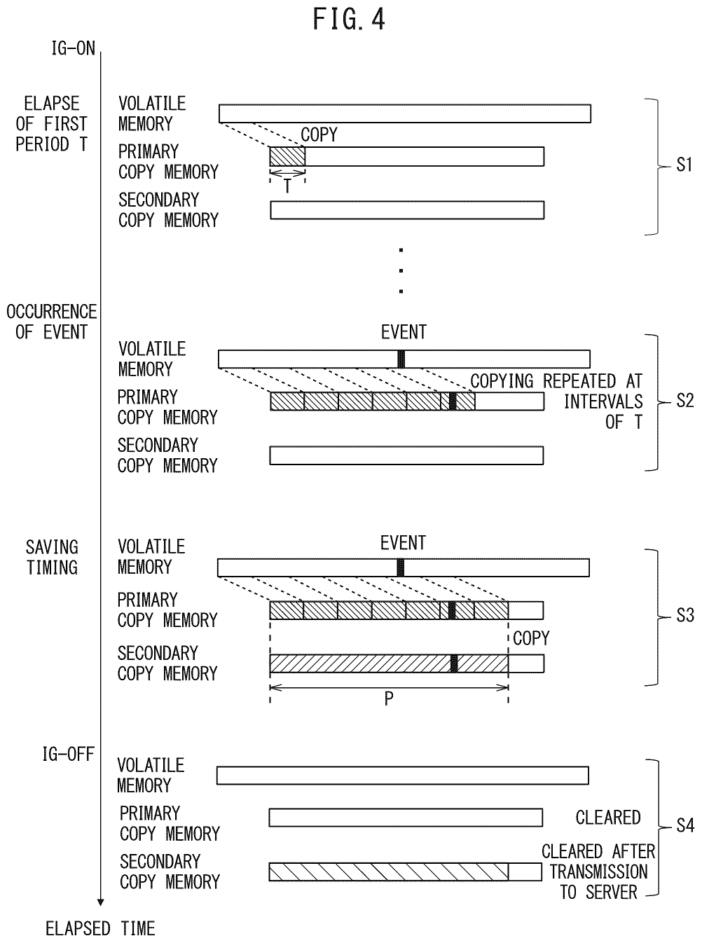

FIG. 4 is a schematic explanatory diagram of the driving data recording process. In FIG. 4, the ordinate represents elapsed time.

After the ignition switch of the vehicle 1 is turned on, driving data is successively stored in the volatile memory 12. When the first period T elapses, driving data for the first period T stored in the volatile memory 12 is copied into the primary copy memory, as illustrated in operating state S1. Copying of driving data into the primary copy memory is repeated every time the first period T elapses. The copying and storing is executed independently of whether a predetermined event has occurred. Thus, even after the occurrence of a predetermined event is detected, driving data is copied from the volatile memory 12 into the primary copy memory as illustrated in operating state S2.

At saving timing after the occurrence of the predetermined event, driving data for the second period that ends at the saving timing is copied from the primary copy memory into the secondary copy memory, as illustrated in operating state S3. As described above, the end of the second period, which follows the timing of detection of occurrence of the event, may precede the saving timing.

Thereafter, when the ignition switch of the vehicle 1 is turned off, driving data for the second period stored in the secondary copy memory is transmitted to the server, and driving data in the primary copy memory and the secondary copy memory is deleted, as illustrated in operating state S4.

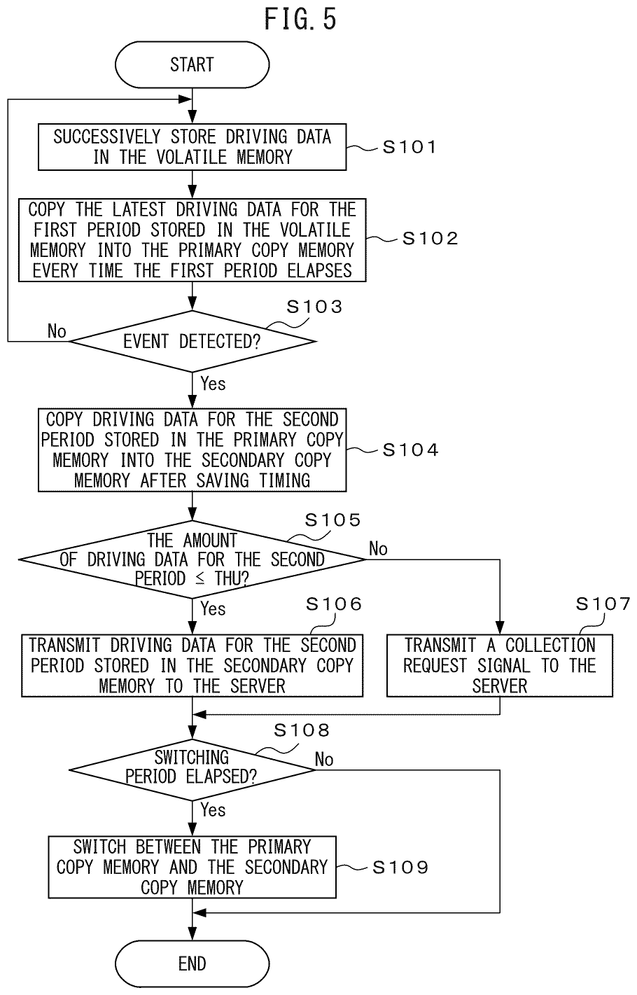

FIG. 5 is an operation flowchart of the driving data recording process. The processor 15 executes the driving data recording process in accordance with the operation flowchart described below.

The storing processing unit 21 successively stores driving data in the volatile memory 12 (step S101). Every time the first period elapses, the first copy processing unit 22 copies the latest driving data for the first period stored in the volatile memory 12 into the primary copy memory, which is one of the first nonvolatile memory 13 and the second nonvolatile memory 14 (step S102).

The detection unit 23 determines whether the occurrence of a predetermined event is detected in or around the vehicle 1 (step S103).

When the occurrence of a predetermined event is not detected (No in step S103), the processor 15 repeats the processing of step S101 and the subsequent steps. When the occurrence of a predetermined event is detected (Yes in step S103), the second copy processing unit 24 copies driving data for the second period stored in the primary copy memory into the secondary copy memory, which is the other one of the first nonvolatile memory 13 and the second nonvolatile memory 14, at saving timing (step S104).

The transmission processing unit 25 determines whether the amount of driving data for the second period stored in the secondary copy memory is less than or equal to a predetermined transmission upper-limit threshold ThU (step S105). When the amount of data is less than or equal to the transmission upper-limit threshold ThU (Yes in step S105), the transmission processing unit 25 transmits driving data for the second period stored in the secondary copy memory to the server via the communication interface 11 and the wireless communication terminal 4 (step S106). When the amount of data exceeds the transmission upper-limit threshold ThU (No in step S105), the transmission processing unit 25 transmits a collection request signal to the server via the communication interface 11 and the wireless communication terminal 4 (step S107).

After step S106 or S107, the switching processing unit 26 determines whether the time elapsed since the last switching between the primary copy memory and the secondary copy memory has reached the switching period (step S108). When the elapsed time has reached the switching period (Yes in step S108), the switching processing unit 26 switches between the primary copy memory and the secondary copy memory (step S109). After step S109 or when the elapsed time has not reached the switching period (No in step S108), the processor 15 terminates the driving data recording process.

In step S108, the switching processing unit 26 may determine whether the number of times of copying of driving data for the first period into the primary copy memory has reached the switching number, as described above. The switching processing unit 26 may execute the processing of step S109 when the number of times of copying has reached the switching number.

As has been described above, the driving data recorder copies, every time a first period elapses, driving data for the first period stored in the volatile memory into one of two nonvolatile memories. At saving timing that is a predetermined time after timing of detection of occurrence of a predetermined event, the driving data recorder further copies driving data for a second period, which includes the timing of detection of occurrence of the event and which is longer than the first period, from the one of the nonvolatile memories into the other nonvolatile memory. The driving data recorder can therefore record driving data for a relatively long period including timing of occurrence of an event during travel of the vehicle.

According to a modified example, the length of the second period may be modified depending on the type of the event that has occurred. In this case, different event detection conditions are preset for different types of event. For example, when the type of event is occurrence of an accident, the event detection condition may be that the absolute value of acceleration or angular velocity is not less than a predetermined threshold. When the type of event is an abnormal occurrence in the driver, the event detection condition may be that an abnormality of the driver is detected from a driver image. For each type of event, the detection unit 23 determines whether the event detection condition corresponding to the type is satisfied. When some event detection condition is satisfied, the detection unit 23 identifies the type of the event that has occurred, as the type corresponding to the satisfied event detection condition. The detection unit 23 then notifies the second copy processing unit 24 of the type of the identified event as well as detection of occurrence of the event.

The second copy processing unit 24 identifies the upper-limit length of the second period corresponding to the type of the event that has occurred and that is identified by the detection unit 23, by referring to a table representing the relationship between the type of event and the upper-limit length of the second period. For example, when the type of the event that has occurred is an abnormal occurrence in the driver, the second period is set longer than when the type of the event that has occurred is an accident. Such a table is prestored in a storage area other than the storage area for driving data in the first nonvolatile memory 13 or the second nonvolatile memory 14. The second copy processing unit 24 executes processing similar to that in the above-described embodiment, depending on the identified upper-limit length of the second period, thereby copying driving data for the second period from the primary copy memory into the secondary copy memory. According to this modified example, the driving data recorder 5 can record driving data having an appropriate length depending on the type of the event that has occurred during travel of the vehicle 1.

In the above-described embodiment or modified examples, the type of data item included in driving data to be transmitted to the server or collected via the external interface, i.e., driving data to be copied into the secondary copy memory may be determined depending on the type of the event that has occurred. For example, when the type of the event that has occurred is an accident, a value indicating motion of the vehicle 1, such as acceleration or angular velocity, a value related to driving operation or control of the vehicle 1, and a vehicle exterior image are determined as the data items. When the type of the event that has occurred is an abnormal occurrence in the driver, a value related to driving operation or control of the vehicle 1 and a driver image are determined as the data items. In this case, the second copy processing unit 24 identifies the type of data item to be included in driving data, by referring to the type of the event detected and identified by the detection unit 23 and a table representing the relationship between the type of event and the type of data item. Such a table is prestored in a storage area other than the storage area for driving data in the first nonvolatile memory 13 or the second nonvolatile memory 14. Out of the driving data stored in the primary copy memory, the second copy processing unit 24 copies the data item of the identified type for the second period into the secondary copy memory. According to this modified example, the driving data recorder 5 can record driving data including an appropriate type of data item depending on the type of the event that has occurred during travel of the vehicle 1.

Driving data transmitted from the driving data recorder according to the above-described embodiment or modified examples to the server or collected via the external interface is used for analyzing the cause of the event or improving an algorithm for driving assistance or autonomous driving control of a vehicle. An improved algorithm for driving assistance or autonomous driving control may be delivered from the server to various vehicles that use these algorithms.

The computer program for achieving the functions of the processor 15 of the driving data recorder 5 according to the above-described embodiment or modified examples may be provided in a form recorded on a computer-readable portable storage medium, such as a semiconductor memory, a magnetic medium, or an optical medium.

As described above, those skilled in the art may make various modifications according to embodiments within the scope of the present disclosure.

What is claimed is:

1. A driving data recorder comprising:
a volatile memory;
a first nonvolatile memory;
a second nonvolatile memory; and
a processor configured to:
store driving data representing condition of a vehicle or an area around the vehicle during travel of the vehicle in the volatile memory,
copy, every time a first period elapses, the driving data for the first period stored in the volatile memory into one of the first nonvolatile memory and the second nonvolatile memory, and
copy driving data for a second period, out of the driving data stored in the one of the nonvolatile memories, from the one of the nonvolatile memories into the other of the first nonvolatile memory and the second nonvolatile memory at saving timing that is a predetermined time after timing of detection of occurrence of a predetermined event, the second period including the timing of detection of occurrence of the event and being longer than the first period.

2. The driving data recorder according to claim 1, wherein the processor is further configured to:
determine whether an amount of driving data for the second period is less than or equal to a predetermined transmission upper-limit threshold,
transmit driving data for the second period stored in the other nonvolatile memory to another device via a communication terminal mounted on the vehicle at transmission timing after the saving timing, when the amount of driving data is less than or equal to the transmission upper-limit threshold, and
transmit a collection request signal to request collection of driving data for the second period to the device via the communication terminal, when the amount of driving data exceeds the transmission upper-limit threshold.

3. The driving data recorder according to claim 1, wherein the processor is further configured to switch between the one of the nonvolatile memories and the other nonvolatile memory, every time a switching period longer than the second period elapses or every time the number of times of copying of driving data for the first period into the one of the nonvolatile memories reaches a predetermined switching number.

4. The driving data recorder according to claim 1, wherein the processor is further configured to detect the occurrence of the predetermined event and that identifies a type of the event that has occurred, wherein
the processor determines a length of the second period, depending on the type of the identified event.

5. The driving data recorder according to claim 1, wherein the processor is further configured to detect the occurrence of the predetermined event and that identifies a type of the event that has occurred, wherein
the processor determines a type of data item included in the driving data to be copied from the one of the nonvolatile memories into the other nonvolatile memory, depending on the type of the identified event.

6. A method for recording driving data, comprising:
storing driving data representing condition of a vehicle or an area around the vehicle during travel of the vehicle in a volatile memory;
copying, every time a first period elapses, the driving data for the first period stored in the volatile memory into one of a first nonvolatile memory and a second nonvolatile memory; and
copying driving data for a second period, out of the driving data stored in the one of the nonvolatile memories, from the one of the nonvolatile memories into the other of the first nonvolatile memory and the second nonvolatile memory at saving timing that is a predetermined time after timing of detection of occurrence of a predetermined event, the second period including the timing of detection of occurrence of the event and being longer than the first period.

7. A non-transitory recording medium that stores a computer program for recording driving data, the computer program causing a processor mounted on a vehicle to execute a process comprising:
storing driving data representing condition of the vehicle or an area around the vehicle during travel of the vehicle in a volatile memory;
copying, every time a first period elapses, the driving data for the first period stored in the volatile memory into one of a first nonvolatile memory and a second nonvolatile memory; and
copying driving data for a second period, out of the driving data stored in the one of the nonvolatile memories, from the one of the nonvolatile memories into the other of the first nonvolatile memory and the second nonvolatile memory at saving timing that is a predetermined time after timing of detection of occurrence of a predetermined event, the second period including the timing of detection of occurrence of the event and being longer than the first period.
